(19) United States
(12) Patent Application Publication
(10) Pub. No.: US 2013/0180261 A1
(43) Pub. Date: Jul. 18, 2013

(54) COMBUSTOR AND METHOD FOR REDUCING THERMAL STRESSES IN A COMBUSTOR

(71) Applicants: Lucas John Stoia, Taylors, SC (US); Patrick Benedict Melton, Horse Shoe, NC (US)

(72) Inventors: Lucas John Stoia, Taylors, SC (US); Patrick Benedict Melton, Horse Shoe, NC (US)

(73) Assignee: GENERAL ELECTRIC COMPANY, Schenectady, NY (US)

(21) Appl. No.: 13/349,932

(22) Filed: Jan. 13, 2012

(51) Int. Cl. F23R 3/26; F23R 3/54; F02C 7/18

(52) U.S. Cl. 60/779; 60/760; 60/806

(57) ABSTRACT

A combustor includes first and second annular casings with a joint between the first and second annular casings. A flow sleeve surrounds a combustion chamber to define an annular passage, and an annular shield inside the first annular casing extends downstream from the joint and prevents a working fluid flowing through the annular passage from contacting at least a portion of the first annular casing. A method for reducing thermal stresses in a combustor includes flowing a working fluid from a compressor through an annular passage between a combustion chamber and a flow sleeve inside the combustor, shielding the working fluid flowing through the annular passage from contact with at least a portion of a joint between first and second annular casings, and shielding the working fluid flowing through the annular passage from contact with at least a portion of the first annular casing downstream from the joint.

### FIELD OF THE INVENTION

The present invention generally involves a combustor, such as may be incorporated into a gas turbine or other turbo-machine, and a method for reducing thermal stresses in the combustor.

### BACKGROUND OF THE INVENTION

Combustors are commonly used in industrial and power generation operations to ignite fuel to produce combustion gases having a high temperature and pressure. For example, gas turbines and other turbo-machines typically include one or more combustors to generate power or thrust. A typical gas turbine used to generate electrical power includes an axial compressor at the front, one or more combustors around the middle, and a turbine at the rear. Ambient air may be supplied to the compressor, and rotating blades and stationary vanes in the compressor progressively impart kinetic energy to the working fluid (air) to produce a compressed working fluid at a highly energized state. The compressed working fluid flows through a compressor discharge plenum, and a casing connected to the compressor discharge plenum contains and directs the compressed working fluid through one or more nozzles in each combustor. The nozzles mix the compressed working fluid with fuel and inject the mixture into a combustion chamber where the mixture ignites to generate combustion gases having a high temperature and pressure. The combustion gases flow through a transition piece to the turbine where they expand to produce work. For example, expansion of the combustion gases in the turbine may rotate a shaft connected to a generator to produce electricity.

In many combustors, the casing that contains and directs the combustion gases through the combustor may include multiple annular sections joined together to circumferentially surround the combustor. In this manner, the multiple annular sections at least partially define a volume inside the combustor, and the compressed working fluid may flow around the combustion chamber to remove heat from the outside of the combustion chamber before flowing through the nozzles and into the combustion chamber.

As the compressed working fluid flows through the volume inside the combustor, the joints or connections between the multiple annular sections of casing may be exposed to substantial thermal gradients. The thermal gradients at the joints or connections in turn create associated thermal stresses that weaken the joints or connections and/or create thermal or flow losses through the joints or connections. The strength of the joints or connections may be increased through the use of more heat resistive materials, larger bolts, and/or higher torques; however, each of these solutions generally increases the cost and/or complexity of the casing. As a result, an improved combustor and methods for reducing thermal stresses in the combustor would be useful.

### BRIEF DESCRIPTION OF THE INVENTION

Aspects and advantages of the invention are set forth below in the following description, or may be obvious from the description, or may be learned through practice of the invention.

One embodiment of the present invention is a combustor that includes an end cover and a first annular casing adjacent to the end cover, wherein the end cover and the first annular casing at least partially define a volume inside the combustor. A second annular casing upstream from the first annular casing circumferentially surrounds at least a portion of a combustion chamber with a connection between the first and second annular casings. A flow sleeve circumferentially surrounds the combustion chamber to define an annular passage between the flow sleeve and the combustion chamber. The combustor further includes means for shielding at least a portion of the first annular casing from a working fluid flowing through the annular passage.

Another embodiment of the present invention is a combustor that includes a first annular casing, and a second annular casing upstream from the first annular casing circumferentially surrounds at least a portion of a combustion chamber with a joint between the first and second annular casings. A flow sleeve circumferentially surrounds the combustion chamber to define an annular passage between the flow sleeve and the combustion chamber, and an annular shield inside the first annular casing extends downstream from the joint and prevents a working fluid flowing through the annular passage from contacting at least a portion of the first annular casing.

The present invention may also include a method for reducing thermal stresses in a combustor that includes flowing a working fluid from a compressor through an annular passage between a combustion chamber and a flow sleeve inside the combustor, shielding the working fluid flowing through the annular passage from contact with at least a portion of a joint between a first annular casing and a second annular casing upstream from the first annular casing, and shielding the working fluid flowing through the annular passage from contact with at least a portion of the first annular casing downstream from the joint.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified cross-section of an exemplary gas turbine that may incorporate various embodiments of the present invention;

FIG. 2 is an enlarged side and partial cross-section view of the combustor shown in FIG. 1 according to a first embodiment of the present invention;

FIG. 3 is a perspective view of the means for shielding shown in FIG. 2 according to the first embodiment of the present invention;

FIG. 4 is an enlarged side and partial cross-section view of the combustor shown in FIG. 1 according to a second embodiment of the present invention;

FIG. 5 is a perspective view of the means for shielding shown in FIG. 4 according to the second embodiment of the present invention;

FIG. 6 is an enlarged side and partial cross-section view of the combustor shown in FIG. 1 according to a third embodiment of the present invention; and

FIG. 7 is a perspective view of the means for shielding shown in FIG. 6 according to the third embodiment of the present invention.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components. In addition, the terms “upstream” and “downstream” refer to the relative location of components in a fluid pathway. For example, component A is upstream from component B if a fluid flows from component A to component B. Conversely, component B is downstream from component A if component B receives a fluid flow from component A.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention include a combustor and method for reducing thermal stresses in the combustor. The combustor generally includes an annular casing having multiple sections joined together to circumferentially surround at least a portion of the combustor. A flow sleeve circumferentially surrounds a combustion chamber to define an annular passage between the flow sleeve and the combustion chamber. An annular shield or other means extends circumferentially inside the annular casing to prevent a working fluid flowing through the annular passage from contacting at least a portion of the annular casing. Although exemplary embodiments of the present invention will be described generally in the context of a combustor incorporated into a gas turbine for purposes of illustration, one of ordinary skill in the art will readily appreciate that embodiments of the present invention may be applied to any combustor and are not limited to a gas turbine combustor or other turbo-machine unless specifically recited in the claims.

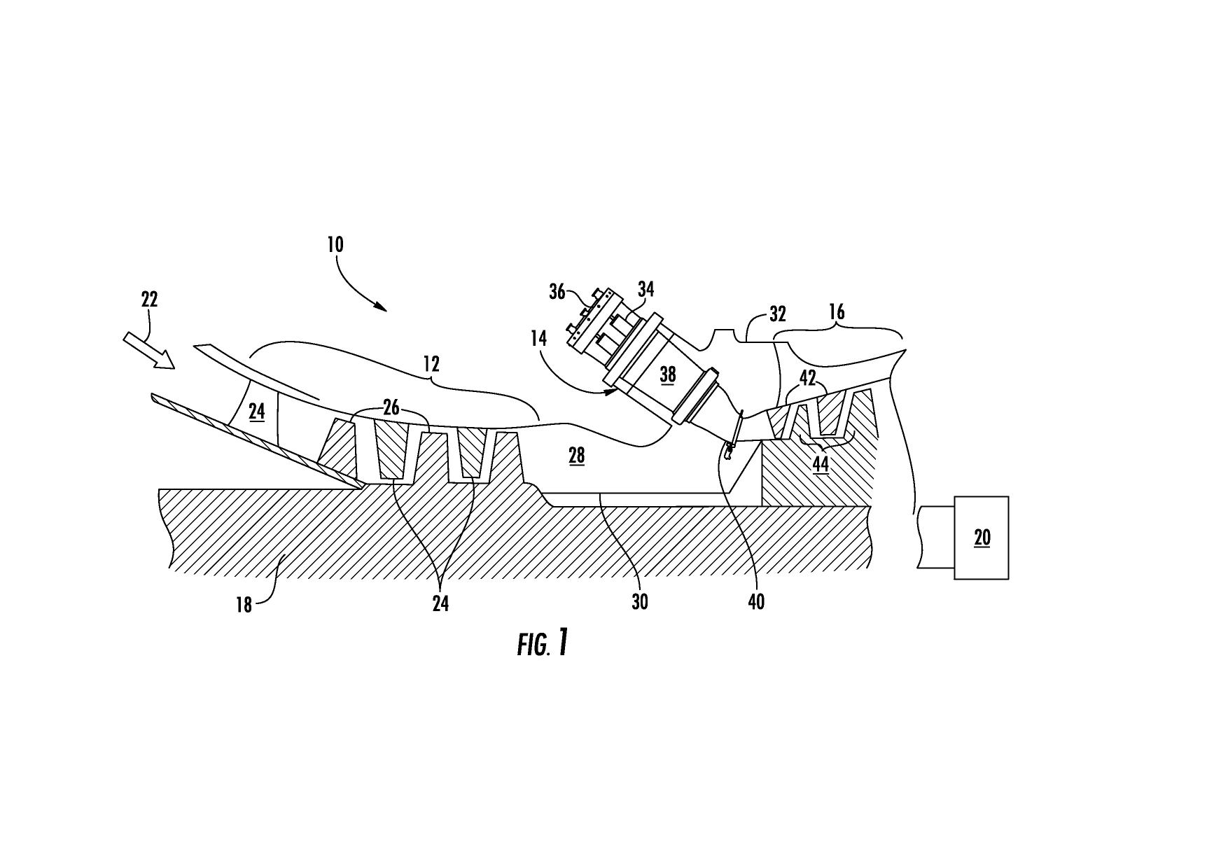

FIG. 1 provides a simplified cross-section of an exemplary gas turbine 10 that may incorporate various embodiments of the present invention. As shown, the gas turbine 10 may generally include a compressor 12 at the front, one or more combustors 14 radially disposed around the middle, and a turbine 16 at the rear. The compressor 12 and the turbine 16 typically share a common rotor 18 connected to a generator 20 to produce electricity.

The compressor 12 may be an axial flow compressor in which a working fluid 22, such as ambient air, enters the compressor 12 and passes through alternating stages of stationary vanes 24 and rotating blades 26. A compressor casing 28 contains the working fluid 22 as the stationary vanes 24 and rotating blades 26 accelerate and redirect the working fluid 22 to produce a continuous flow of compressed working fluid 22. The majority of the compressed working fluid 22 flows through a compressor discharge plenum 30 to the combustor 14.

The combustor 14 may be any type of combustor known in the art. For example, as shown in FIG. 1, a combustor casing 32 may circumferentially surround some or all of the combustor 14 to contain the compressed working fluid 22 flowing from the compressor 12. One or more fuel nozzles 34 may be radially arranged in an end cover 36 to supply fuel to a combustion chamber 38 downstream from the fuel nozzles 34. Possible fuels include, for example, one or more of blast furnace gas, coke oven gas, natural gas, vaporized liquefied natural gas (LNG), hydrogen, and propane. The compressed working fluid 22 may flow from the compressor discharge plenum 30 along the outside of the combustion chamber 38 before reaching the end cover 36 and reversing direction to flow through the fuel nozzles 34 to mix with the fuel. The mixture of fuel and compressed working fluid 22 flows into the combustion chamber 38 where it ignites to generate combustion gases having a high temperature and pressure. The combustion gases flow through a transition piece 40 to the turbine 16.

The turbine 16 may include alternating stages of stators 42 and rotating buckets 44. The first stage of stators 42 redirects and focuses the combustion gases onto the first stage of turbine buckets 44. As the combustion gases pass over the first stage of turbine buckets 44, the combustion gases expand, causing the turbine buckets 44 and rotor 18 to rotate. The combustion gases then flow to the next stage of stators 42 which redirects the combustion gases to the next stage of rotating turbine buckets 44, and the process repeats for the following stages.

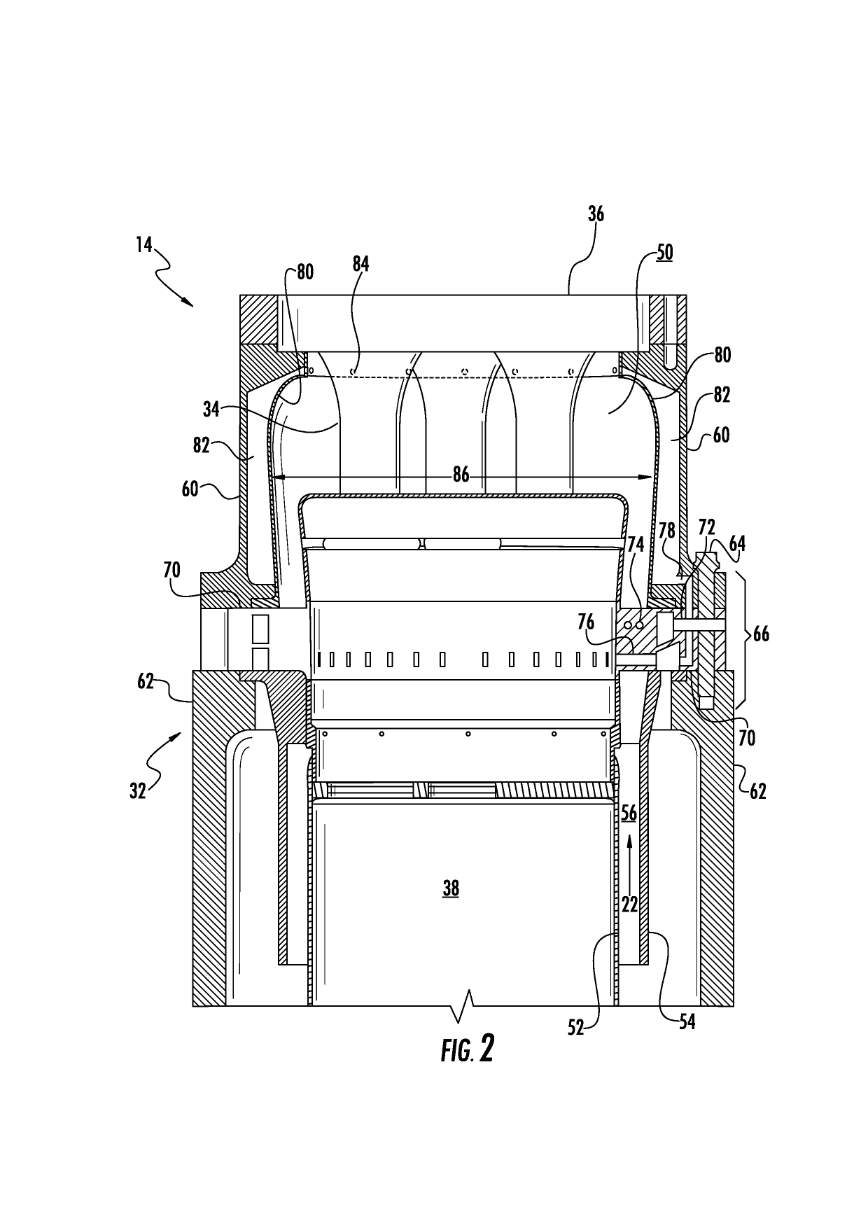

FIG. 2 provides an enlarged side view and partial cross-section of the combustor 14 shown in FIG. 1 according to a first embodiment of the present invention. As shown, the combustor casing 32 and end cover 36 define a volume 50, also referred to as the head end, inside the combustor 14, and a liner 52 circumferentially surrounds and defines at least a portion of the combustion chamber 38. A flow sleeve 54 may circumferentially surround at least a portion of the combustion chamber 38 to define an annular passage 56 between the flow sleeve 54 and the liner 52. In this manner, the working fluid 22 may flow through the annular passage 56 to provide convective cooling to the liner 24. When the working fluid 22 reaches the head end or volume 50, the working fluid 22 reverses direction to flow through one or more fuel nozzles 34 and into the combustion chamber 38.

The combustor casing 32 may include multiple annular sections that facilitate assembly and/or accommodate thermal expansion during operations. For example, as illustrated in the particular embodiment shown in FIG. 2, the combustor casing 32 may include a first annular casing 60 adjacent to the end cover 36 and a second annular casing 62 upstream from the first annular casing 60. A clamp, weld bead, and/or plurality of bolts 64 may circumferentially surround the combustor 14 to provide a connection or joint 66 between the first and second annular casings 60, 62. In particular embodiments, a flange 70 may extend radially between the first and second annular casings 60, 62, and the flange 70 may include one or more internal fluid passages that provide fluid communication through the connection 66. For example, the flange 70 may include a fuel passage 72 that provides a fluid pathway through the first and second annular casings 60, 62 so fuel may flow through quaternary fuel ports 74 to mix with the working fluid 22 flowing into the volume 50. Alternately, or in addition, the flange 70 may include a first diluent passage 76 that provides a fluid pathway for the working fluid 22 to flow into or around the fuel nozzles 34 before flowing into the combustion chamber 38.

As the working fluid 22 flows through the annular passage 56 and into the volume 50 inside the combustor 14, the working fluid 22 may create substantial thermal gradients across the connection 66 between the first and second annular casings 60, 62. If not shielded, the thermal gradients may create thermal stresses that distort the first annular casing 60, weaken the connection 66, and/or create thermal or flow losses through the connection 66. As a result, various embodiments of the present invention include means for shielding at least a portion the first annular casing 60 from the working fluid 22 flowing through the annular passage 56. As used herein, the function of the means includes preventing the working fluid 22 flowing through the annular passage 56 from direct contact with at least a portion of the first annular casing 60. In particular embodiments, the means may further prevent the working fluid 22 flowing through the annular passage 56 from direct contact with the entire first annular casing 60 and/or at least a portion of the connection 66. By preventing the working fluid 22 flowing through the annular passage 56 from direct contact with at least a portion of the first annular casing 60, the means may reduce the heat transfer coefficient across the first annular casing 60 which subsequently reduces thermal losses through the first annular casing 60. In addition, the means may produce a substantially isothermal profile across the combustor casing 32 which greatly reduces distortion of the combustor casing 32, thus improving the robustness of the connection 66.

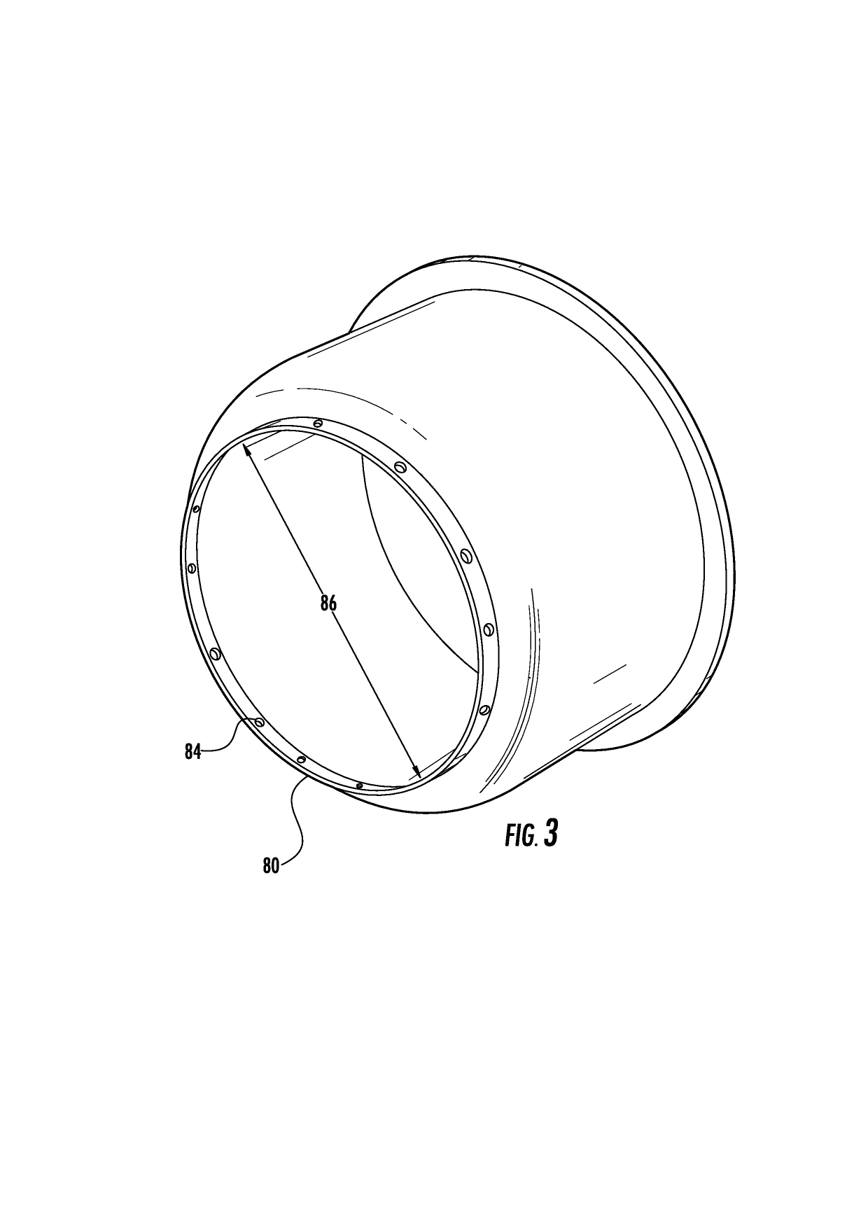

The structure for the means for shielding at least a portion of the first annular casing 60 from the working fluid 22 may be an insert or annular shield 80, and FIG. 3 provides a perspective view of the annular shield 80 shown in FIG. 2. In the particular embodiment shown in FIGS. 2 and 3, the annular shield 80 extends inside the volume 50 from the connection 66 between the first and second annular casings 60, 62 to the end cover 36. The annular shield 80 may be press-fit, bolted, or otherwise connected to one or more of the end cover 36, the first annular casing 60, or the radially extending flange 70. In this manner, the annular shield 80 at least partially defines an annular volume 82 between the annular shield 80 and the first annular casing 60 that prevents the working fluid 22 flowing through the annular passage 56 from direct contact with any portion of the first annular casing 60. A second diluent passage 78 through the flange 70 and weep holes 84 in the annular shield may provide a fluid pathway for a portion of the working fluid 22 that flows outside of the annular passage 56 to continuously purge the annular volume 82. In addition, the annular shield 80 may define a diameter 86 that decreases as the annular shield 80 extends downstream from the connection or joint 66 to guide the working fluid 22 and reduce low flow regions of the working fluid 22 inside the head end 50.

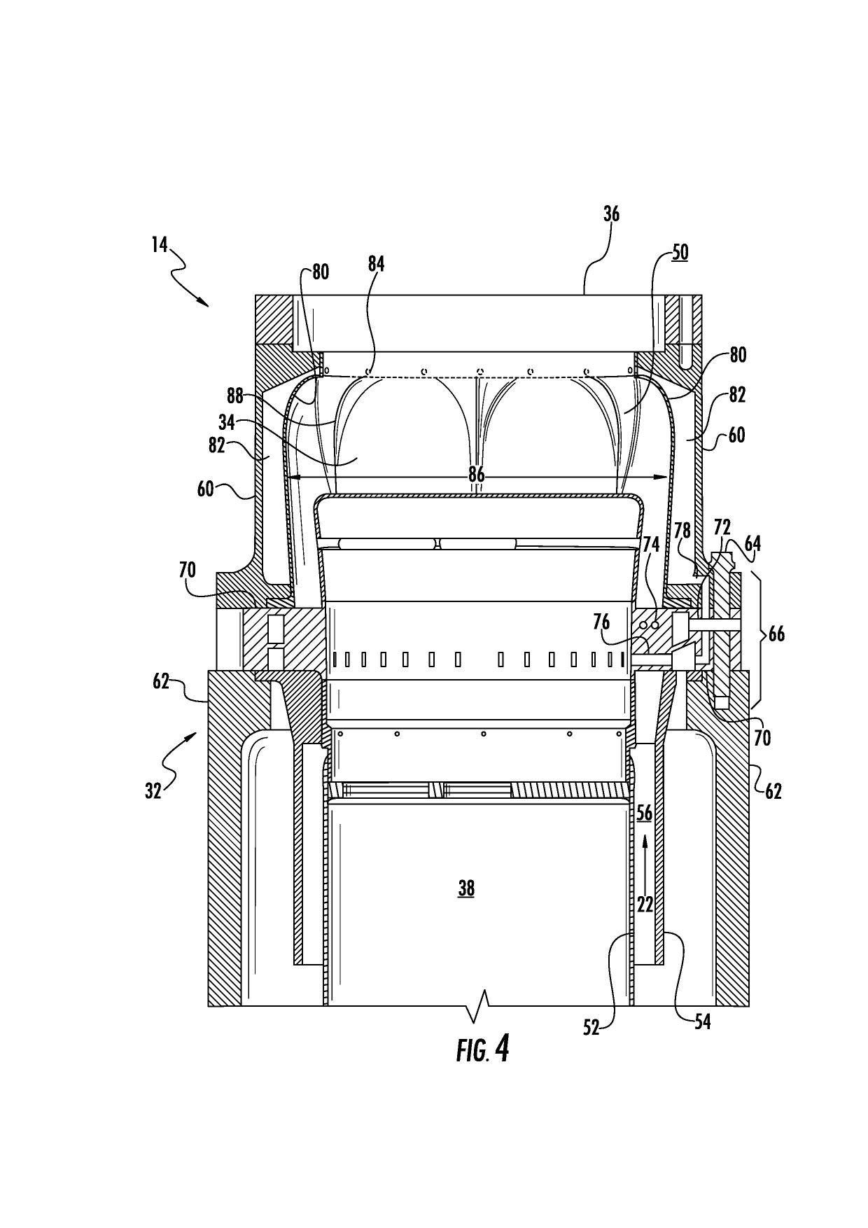

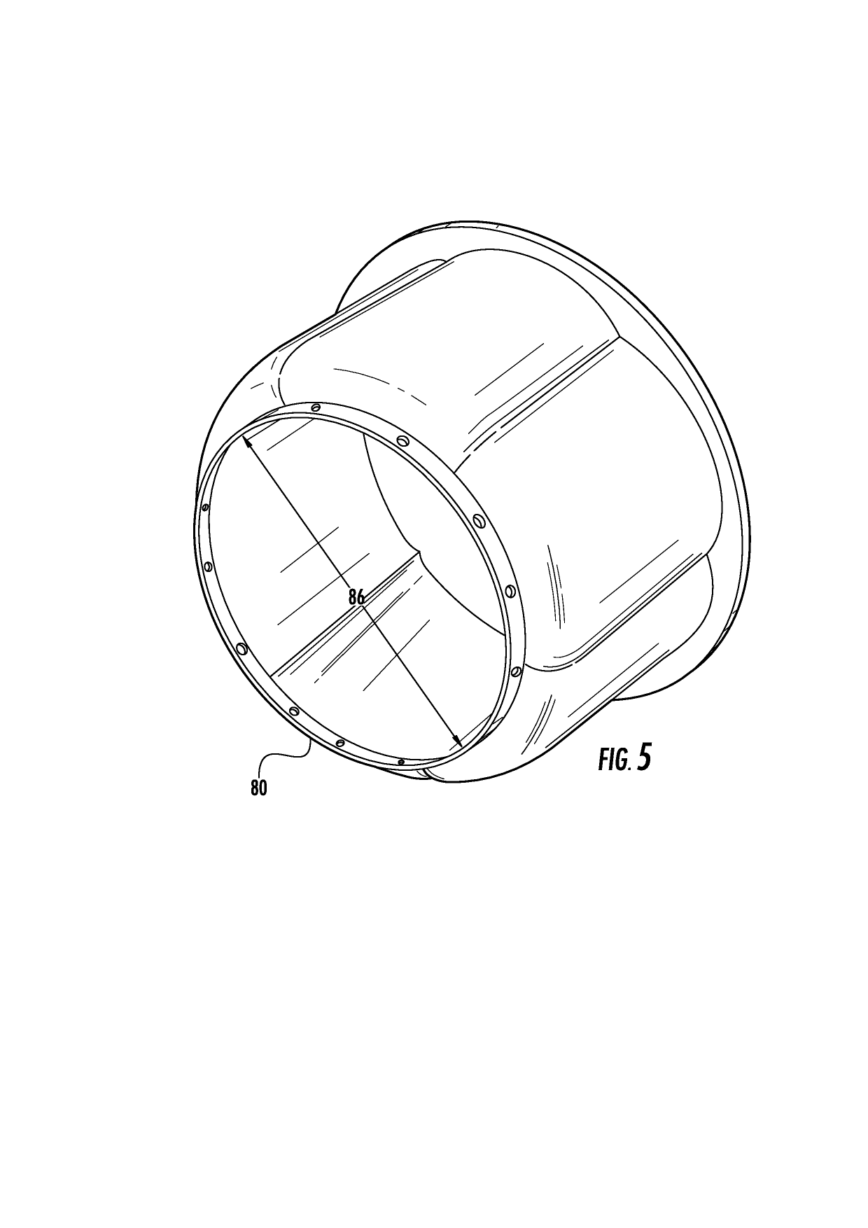

FIG. 4 provides a side view of the combustor 14 according to a second embodiment of the present invention, and FIG. 5 provides a perspective view of the means for shielding at least a portion of the first annular casing 60 from the working fluid 22 shown in FIG. 4 according to the second embodiment of the present invention. As in the previous embodiment shown in FIGS. 2 and 3, the annular shield 80 again extends inside the volume 50 from the connection 66 between the first and second annular casings 60, 62 to the end cover 36 to prevent the working fluid 22 flowing through the annular passage 56 from direct contact with any portion of the first annular casing 60. In addition, the diameter 86 defined by the annular shield 80 again decreases as the annular shield 80 extends downstream from the connection or joint 66 to guide the working fluid 22 and reduce low flow regions of the working fluid 22 inside the head end 50. In the particular embodiment shown in FIGS. 4 and 5, the annular shield 80 defines a plurality of flow guides 88 that extend axially downstream from the connection or joint 66. The flow guides 88 radially separate the working fluid 22 flow in the head end 50 to enhance distribution of the working fluid 22 flowing into the fuel nozzles 34. The flow guides 88 may be straight or angular features in the annular shield 80. Alternately, as shown most clearly in FIG. 5, the flow guides 88 may be arcuate surfaces formed in the annular shield 80 at specific intervals around the circumference of the annular shield 80.

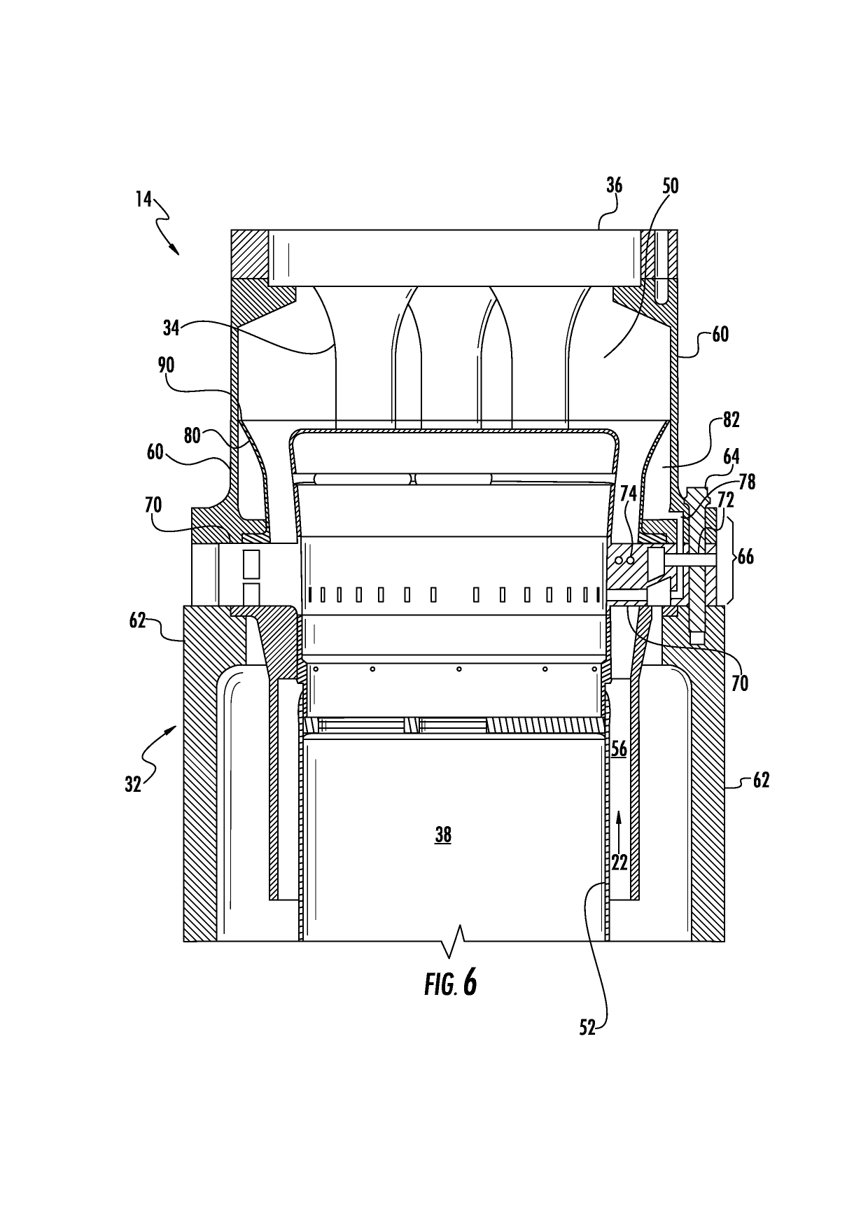

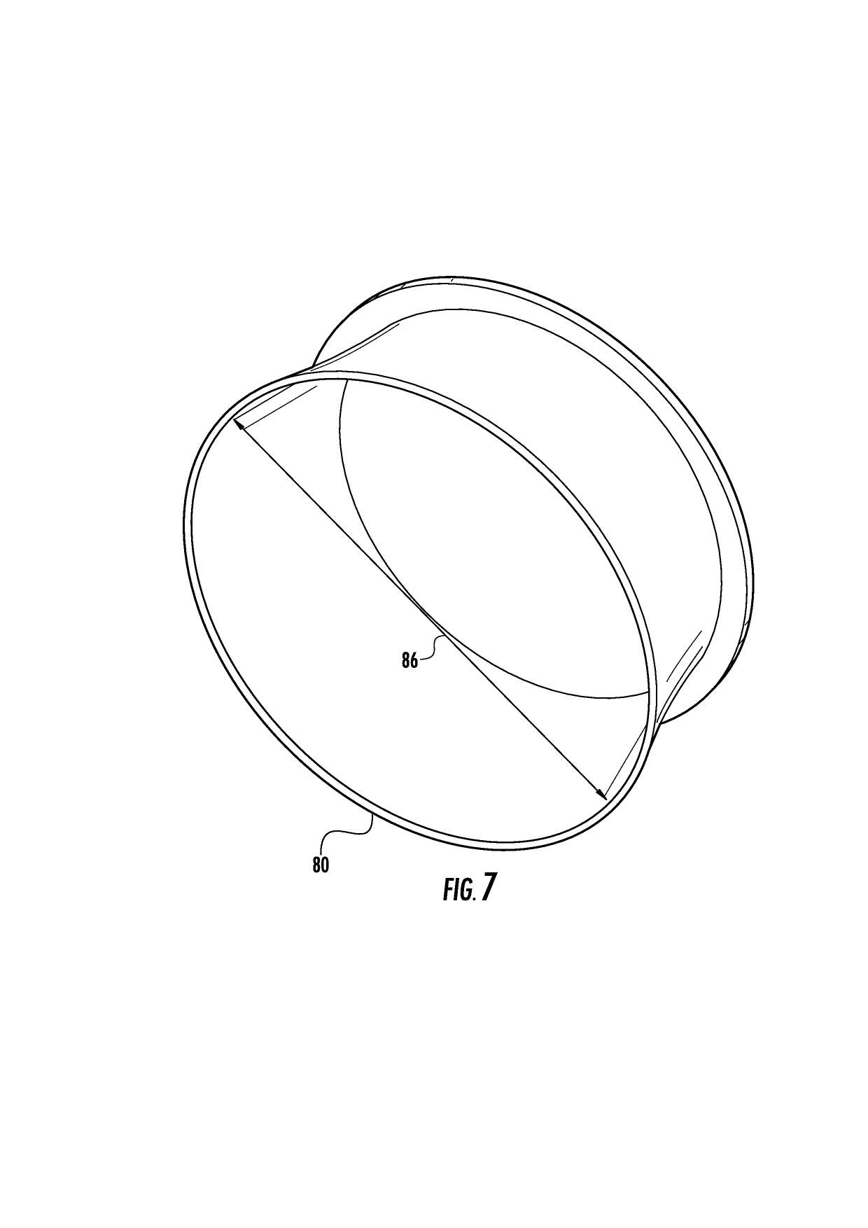

FIG. 6 provides a side view of the combustor 14 according to a third embodiment of the present invention, and FIG. 7 provides a perspective view of the means for shielding at least a portion of the first annular casing 60 flowing through the annular passage 56 from the working fluid 22 shown in FIG. 6 according to the third embodiment of the present invention. In the particular embodiment shown in FIGS. 6 and 7, the annular shield 80 extends inside the volume 50 from the connection 66 between the first and second annular casings 60, 62 to a point 90 along the first annular casing 60. The annular shield 80 may be press-fit, bolted, or otherwise connected to one or more of the first annular casing 60 or the radially extending flange 70. In this manner, the annular volume 82 between the annular shield 80 and the first annular casing 60 prevents the working fluid 22 flowing through the annular passage 56 from direct contact with a portion of the first annular casing 60. In addition, the diameter 86 defined by the annular shield 80 may increase as the annular shield 80 extends downstream from the connection or joint 66 to moderate the reduction in the head end volume 50 caused by the annular shield 80. As a result, head end volume 50 allows for adequate mixing between the working fluid 22 and fuel injected through the fuel ports 74 before flowing through the fuel nozzles 34.

The various embodiments shown in FIGS. 1-7 may also provide a method for reducing thermal stresses in the combustor 14. The method may include flowing the working fluid 22 from the compressor 12 through the annular passage 56 between the combustion chamber 38 and the flow sleeve 54 inside the combustor 14, shielding the working fluid 22 flowing through the annular passage 56 from contact with at least a portion of the joint 66 and/or at least a portion of the first annular casing 60 downstream from the joint 66. In particular embodiments, the method may further include shielding the working fluid 22 flowing through the annular passage 56 from contact with the entire first annular casing 60 and/or directing the working fluid 22 through flow guides 86 that distribute the working fluid 22 inside the combustor 14.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A combustor comprising:
a. an end cover;
b. a first annular casing adjacent to the end cover, wherein the end cover and the first annular casing at least partially define a volume inside the combustor;
c. a second annular casing upstream from the first annular casing, wherein the second annular casing circumferentially surrounds at least a portion of a combustion chamber;
d. a connection between the first and second annular casings;
e. a flow sleeve that circumferentially surrounds the combustion chamber to define an annular passage between the flow sleeve and the combustion chamber; and
f. means for shielding at least a portion of the first annular casing from a working fluid flowing through the annular passage.

2. The combustor as in claim 1, wherein the means for shielding extends inside the volume from the connection between the first and second annular casings to the end cover.

3. The combustor as in claim 1, wherein the means for shielding extends inside the volume from the connection between the first and second annular casings to a point along the first annular casing.

4. The combustor as in claim 1, further comprising a radially extending flange between the first and second annular casings.

5. The combustor as in claim 4, wherein the means for shielding is connected to at least one of the end cover, the first annular casing, or the radially extending flange.

6. The combustor as in claim 4, further comprising a fluid passage inside the radially extending flange between the first and second annular casings.

7. The combustor as in claim 6, wherein the fluid passage provides fluid communication into the volume.

8. A combustor comprising:
a. a first annular casing;
b. a second annular casing upstream from the first annular casing, wherein the second annular casing circumferentially surrounds at least a portion of a combustion chamber;
c. a joint between the first and second annular casings;
d. a flow sleeve that circumferentially surrounds the combustion chamber to define an annular passage between the flow sleeve and the combustion chamber; and
e. an annular shield inside the first annular casing, wherein the annular shield extends downstream from the joint and prevents a working fluid flowing through the annular passage from contacting at least a portion of the first annular casing.

9. The combustor as in claim 8, wherein the annular shield connects to the first annular casing downstream from the joint to at least partially define a volume inside the combustor.

10. The combustor as in claim 8, wherein the annular shield defines a diameter inside the combustor that decreases downstream from the joint.

11. The combustor as in claim 8, wherein the annular shield defines a diameter inside the combustor that increases downstream from the joint.

12. The combustor as in claim 8, wherein the annular shield defines a plurality of flow guides that extend axially downstream from the joint.

13. The combustor as in claim 12, wherein the flow guides are arcuate.

14. The combustor as in claim 8, further comprising an end cover downstream from the first annular casing, wherein the annular shield connects to the end cover to at least partially define a volume inside the combustor.

15. The combustor as in claim 8, further comprising a radially extending flange between the first and second annular casings.

16. The combustor as in claim 15, wherein the annular shield is connected to at least one of the first annular casing or the radially extending flange.

17. The combustor as in claim 15, further comprising a fluid passage inside the radially extending flange between the first and second annular casings.

18. A method for reducing thermal stresses in a combustor, comprising:
a. flowing a working fluid from a compressor through an annular passage between a combustion chamber and a flow sleeve inside the combustor;
b. shielding the working fluid flowing through the annular passage from contact with at least a portion of a joint between a first annular casing and a second annular casing upstream from the first annular casing; and
c. shielding the working fluid flowing through the annular passage from contact with at least a portion of the first annular casing downstream from the joint.

19. The method as in claim 18, further comprising shielding the working fluid flowing through the annular passage from contact with the entire first annular casing.

20. The method as in claim 18, further comprising directing the working fluid flowing through the annular passage through flow guides that distribute the working fluid inside the combustor.
